(19) United States
(12) Patent Application Publication
(10) Pub. No.: US 2020/0285161 A1
(43) Pub. Date: Sep. 10, 2020

(54) TONER

(71) Applicant: KYOCERA Document Solutions Inc., Osaka (JP)

(72) Inventor: Toru TAKATSUNA, Osaka-shi (JP)

(73) Assignee: KYOCERA Document Solutions Inc., Osaka (JP)

(21) Appl. No.: 16/807,248

(22) Filed: Mar. 3, 2020

(30) Foreign Application Priority Data
Mar. 7, 2019 (JP) 2019-041740

(51) Int. Cl. G03G 9/08; G03G 9/087; G03G 9/083

(52) U.S. Cl. CPC G03G 9/0819; G03G 9/0839; G03G 9/08755

(57) ABSTRACT

A toner includes toner particles each including a toner mother particle. The toner mother particles contain a binder resin, a magnetic powder, and conductive titanium oxide particles. The conductive titanium oxide particles have an aspect ratio of at least 5.0. The amount of the conductive titanium oxide particles is at least 2 parts by mass and no greater than 10 parts by mass relative to 100 parts by mass of the binder resin.

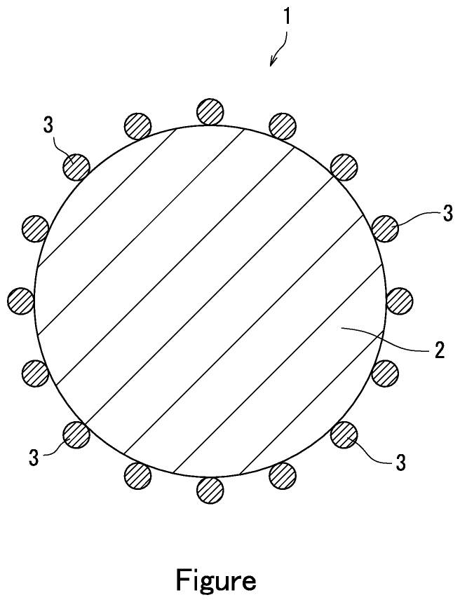

### INCORPORATION BY REFERENCE

The present application claims priority under 35 U.S.C. § 119 to Japanese Patent Application No. 2019-41740, filed on Mar. 7, 2019. The contents of this application are incorporated herein by reference in their entirety.

### BACKGROUND

The present disclosure relates to a toner.

A toner including toner particles each including a toner mother particle is used in electrophotographic image formation. The toner mother particles contain for example a binder resin and a magnetic powder. For example, a toner such as above is controlled by magnetic force in a development device to be gradually charged between a magnet provided in a development roller and a magnetic blade provided out of contact with the development roller.

### SUMMARY

A toner according to an aspect of the present disclosure includes toner particles each including a toner mother particle. The toner mother particles contain a binder resin, a magnetic powder, and conductive titanium oxide particles. The conductive titanium oxide particles have an aspect ratio of at least 5.0. An amount of the conductive titanium oxide particles is at least 2 parts by mass and no greater than 10 parts by mass relative to 100 parts by mass of the binder resin.

### BRIEF DESCRIPTION OF THE DRAWINGS

FIGURE is a schematic cross-sectional view of an example of a toner particle included in a toner according to the present disclosure.

### DETAILED DESCRIPTION

The following describes a preferable embodiment of the present disclosure. Note that the toner is a collection (for example, a powder) of toner particles. An external additive herein is a collection (for example, a powder) of external additive particles. Evaluation results (values indicating shape, physical properties, or the like) for a powder (specific examples include a powder of toner particles and a powder of external additive particles) each are a number average value measured with respect to an appropriate number of particles of the powder unless otherwise stated.

Values for volume median diameter (D₅₀) of a powder each are a value measured based on the Coulter principle (electrical sensing zone technique) using “Coulter Counter Multisite 3” produced by Beckman Coulter, Inc. unless otherwise stated.

A number average primary particle diameter of a powder is a number average value of equivalent circle diameters of primary particles of the powder (Heywood diameter: diameters of circles having the same areas as projected areas of the primary particles) measured using a scanning electron microscope unless otherwise stated. The number average primary particle diameter of a powder is a number average value of equivalent circle diameters of for example 100 primary particles. Note that a number average primary particle diameter of particles is a number average primary particle diameter of the particles of a powder unless otherwise stated.

Chargeability refers to chargeability in triboelectric charging unless otherwise stated. Positive chargeability (or negative chargeability) in triboelectric charging can be determined using a known triboelectric series or the like.

Unless otherwise stated, a “main component” of a material refers to a component contained the most in the material in terms of mass.

A level of hydrophobicity (or a level of hydrophilicity) can be expressed for example in terms of a contact angle of a water drop (wettability to water). The larger the contact angel of a water drop is, the higher the level of hydrophobicity is.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof.

### <Toner>

A toner according to an embodiment of the present disclosure includes toner particles each including a toner mother particle. The toner mother particles contain a binder resin, a magnetic powder, and conductive titanium oxide particles. The conductive titanium oxide particles have an aspect ratio of at least 5.0. The amount of the conductive titanium oxide particles is at least 2 parts by mass and no greater than 10 parts by mass relative to 100 parts by mass of the binder resin.

The toner according to the present embodiment is favorably used as for example a positively chargeable magnetic toner (one-component developer) for development of electrostatic latent images.

The toner according to the present disclosure having the above features is excellent in image density stability, and use of the toner can prevent occurrence of fogging and toner scattering. The reason therefor will be described below. The toner according to the present disclosure forms toner chains (a magnetic brush) each constituted by approximately 10 toner particles on a development roller in a development device. In each toner chain, a lowermost toner particle is charged through contact with a surface of the development roller (contact charge) and the generated charge propagates in the toner chain to charge upper toner particles. The toner according to the present disclosure has appropriate conductivity because of internal addition of a specific amount of the conductive titanium oxide particles in the form of needles (specifically, having an aspect ratio of at least 5.0) to the toner mother particles. As a result, charge readily propagates from the lowermost toner particle to the upper toner particles in each of the toner chains formed in the toner, thereby achieving sufficient charging of each toner particles. Therefore, use of the toner according to the present disclosure can prevent occurrence of fogging and toner scattering and reduction in image density which are caused due to insufficient charge amount or variation in charge amount of the toner particles.

The following provides further detailed description of the toner. Note that components listed in the following descriptions may be used singly or in combination of two or more thereof unless otherwise stated.

### [Toner Particles]

FIGURE illustrates an example of a toner particle 1 included in the toner. The toner particle 1 illustrated in FIGURE includes a toner mother particle 2 and an external additive attached to a surface of the toner mother particle 2. The external additive includes external additive particles 3.

However, the toner particles included in the toner according to the present disclosure may have a structure different from the toner particle 1 illustrated in FIGURE. Specifically, the toner particles may include no external additive. Alternatively or additionally, the toner particles may each be a toner particle including a shell layer (also referred to below as a capsule toner particle). In the capsule toner particles, each toner mother particle includes a toner core and a shell layer. The toner cores contain for example a binder resin, a magnetic powder, and conductive titanium oxide particles. The shell layers cover surfaces of the respective toner cores. The toner particles included in the toner according to the present disclosure have been described in detail with reference to FIGURE.

### [Toner Mother Particles]

The toner mother particles contain a binder resin, a magnetic powder, and conductive titanium oxide particles. The toner mother particles may further contain an internal additive other than the magnetic powder and the conductive titanium oxide particles (for example, at least one of a colorant, a releasing agent, and a charge control agent) as necessary. Examples of a toner mother particle production method include a pulverization method and an aggregation method, and the pulverization method is preferable.

In terms of favorable image formation, the toner mother particles preferably have a volume median diameter (D₅₀) of at least 4 μm and no greater than 9 μm.

### (Binder Resin)

The toner mother particles contain for example a binder resin as a main component. In terms of providing a toner excellent in low-temperature fixability, the toner mother particles preferably contain a thermoplastic resin as the binder resin and more preferably contain the thermoplastic resin in an amount of at least 85% by mass of a total mass of the binder resin. Examples of the thermoplastic resin include styrene-based resins, acrylic acid ester-based resins, olefin-based resins (specific examples include polyethylene resin and polypropylene resin), vinyl resins (specific examples include vinyl chloride resin, polyvinyl alcohol, vinyl ether resin, and N-vinyl resin), polyester resins, polyamide resins, and urethane resins. Copolymers of the resins listed above, that is, copolymers of the resins listed above into which any repeating unit is introduced (specific examples include styrene-acrylic ester-based resins and styrene-butadiene-based resins) can be used as the binder resin. A preferable binder resin is a polyester resin, and a more preferable binder resin is a non-crystalline polyester resin.

A content rate of the binder resin in the toner mother particles is preferably at least 30% by mass and no greater than 90% by mass, and more preferably at least 40% by mass and no greater than 70% by mass.

### (Magnetic Powder)

Examples of materials of the magnetic powder that can be favorably used include ferromagnetic metals (specific examples include iron, cobalt, nickel, and alloys including at least one of these metals), ferromagnetic metal oxides (specific examples include ferrite, magnetite, and chromium dioxide), and materials subjected to ferromagnetization (specific examples include carbon materials to which ferromagnetism is imparted through thermal treatment).

In terms of favorable image formation, the amount of the magnetic powder contained in the toner mother particles is preferably at least 40 parts by mass and no greater than 120 parts by mass relative to 100 parts by mass of the binder resin and more preferably at least 60 parts by mass and no greater than 90 parts by mass.

The magnetic powder preferably has a number average primary particle diameter of at least 0.1 μm and no greater than 1.0 μm, and more preferably at least 0.1 μm and no greater than 0.3 μm.

The magnetic powder is preferably subjected to surface treatment in order to inhibit elution of metal ions (for example, iron ions) from the magnetic powder. Elution of metal ions to surfaces of the toner mother particles tends to lead adhesion of toner mother particles to one another. It is thought that inhibition of metal ion elution from the magnetic powder can inhibit adhesion of toner mother particles to one another.

### (Conductive Titanium Oxide Particles)

The conductive titanium oxide particles are titanium oxide particles subjected to treatment to impart conductivity. The conductive titanium oxide particles contain for example titanium oxide (TiO₂) as a main component. An aspect ratio (major axis/minor axis) of the conductive titanium oxide particles is at least 5.0. The aspect ratio of the conductive titanium oxide particles is preferably at least 5.0 and no greater than 50.0, more preferably at least 10.0 and no greater than 30.0, and further preferably at least 15.0 and no greater than 25.0. Conductive titanium oxide particles having a needle shape with such a high aspect ratio can impart higher conductivity to toner particles than conductive titanium oxide particles having a ball shape with a low aspect ratio even if the respective amounts thereof are the same as each other. Therefore, the conductive titanium oxide particles having an aspect ratio of at least 5.0 can impart appropriate conductivity to the toner particles. Thus, each toner particle of toner chains formed in the toner according to the present disclosure can be sufficiently charged.

The major axis of the conductive titanium oxide particles is preferably at least 1.0 μm and no greater than 10.0 μm, and more preferably at least 2.5 μm and no greater than 7.0 μm. The conductive titanium oxide particles having a major axis of at least 1.0 μm and no greater than 10.0 μm can facilitate impartment of appropriate conductivity to the toner particles. As a result, each toner particle of toner chains formed in the toner according to the present disclosure is sufficiently charged.

Note that a value for the major axis of the conductive titanium oxide particles is an arithmetic mean value of major axes of 100 conductive titanium oxide particles measured using an electron microscope. Also, an aspect ratio of the conductive titanium oxide particles is an arithmetic mean value of aspect ratios of 100 conductive titanium oxide particles measured using an electron microscope.

The conductive titanium oxide particles each preferably have a base containing titanium oxide and a conductive layer covering the base. The bases are preferably titanium oxide particles having an aspect ratio of at least 5.0. For example, rutile type titanium oxide (TiO₂) particles can be used as the bases. The content percentage of titanium oxide in the bases is preferably at least 90% by mass, more preferably 99% by mass, and further preferably 100% by mass.

The conductive layers contain a conductive compound. Examples of the conductive compound include metal oxides such as tin oxides and zinc oxides. Examples of the tin oxides include antimony doped tin oxide (ATO), indium tin oxide (ITO), and fluorine doped tin oxide (FTO). Examples of the zinc oxides include aluminum doped zinc oxide (AZO) and gallium doped zinc oxide (GZO). A tin oxide is preferable as the conductive compound, and ATO or ITO is more preferable. The content percentage of the conductive compound in the conductive layers is preferably at least 90% by mass, more preferably at least 99% by mass, and further preferably 100% by mass.

The mass of the conductive layers is preferably at least 5 parts by mass and no greater than 60 parts by mass relative to 100 parts by mass of the bases, and more preferably at least 20 parts by mass and no greater than 40 parts by mass. The mass of the conductive layers being at least 5 parts by mass and no greater than 60 parts by mass can facilitate impartment of appropriate conductivity to the toner particles. Accordingly, each toner particle of toner chains formed in the toner according to the present disclosure can be sufficiently charged.

The amount of the conductive titanium oxide particles in the toner mother parties is preferably at least 2 parts by mass and no greater than 10 parts by mass relative to 100 parts by mass of the binder resin, and preferably at least 5 parts by mass and no greater than 10 parts by mass. As a result of the amount of the conductive titanium oxide particles being at least 2 parts by mass and no greater than 10 parts by mass, appropriate conductivity can be imparted to the toner particles. Accordingly, each toner particle of toner chains formed in the toner according to the present disclosure can be sufficiently charged.

### (Preparation Method of Conductive Titanium Oxide Particles)

The conductive titanium oxide particles can be obtained by covering the bases with the conductive layers, for example.

An example of a base preparation method will be described below. First, a slurry containing rutile type titanium oxide is prepared by hydrolyzing an aqueous solution of titanium tetrachloride in presence of seed crystals of rutile type titanium oxide. The amount of the seed crystals of rutile type titanium oxide is preferably at least 0.5 parts by mass and no greater than 30.0 parts by mass relative to 100 parts by mass of titanium oxide generated from titanium tetrachloride in terms of a theoretical mass yield thereof, and more preferably at least 5.0 parts by mass and no greater than 10.0 parts by mass. The hydrolysis can be performed for example under conditions of a heating temperature of 70° C. or higher and 95° C. or lower and a heating time of 1 hour or longer and 4 hours or shorter.

Next, an alkali metal compound (for example, sodium carbonate) is added to the slurry containing rutile type titanium oxide for pH adjustment (for example, to a pH of at least 3.0 and no greater than 5.0), and then, an oxyphosphorus compound is further added thereto. The amount of the oxyphosphorus compound is for example at least 15 parts by mass and no greater than 60 parts by mass relative to 100 parts by mass of rutile type titanium oxide. Thereafter, the slurry was filtered and the resultant residue is baked, thereby obtaining bases that are the titanium oxide particles having an aspect ratio of at least 5.0. The baking can be performed under conditions of for example a heating temperature of 700° C. or higher and 1,000° C. or lower and a heating time of 1 hour or longer and 6 hours or shorter.

Examples of a method for preparing the seed crystals of rutile type titanium oxide include the following first to fourth methods. In the first method, an aqueous solution of titanium tetrachloride is hydrolyzed at its boiling point. In the second method, an aqueous solution of titanium sulfate or an aqueous solution of titanium tetrachloride is neutralized with an alkaline aqueous solution (for example, an aqueous solution of sodium hydroxide) and precipitated colloidal titanium hydroxide is heat aged. In the third method, the above colloidal titanium hydroxide is heat aged in sodium hydroxide and then heat aged in hydrochloric acid. In the fourth method, a product obtained by any of the first to third methods is dried, and then, the dried product, an alkali metal compound, and an oxyphosphorus compound are mixed and baked. The seed crystals of rutile type titanium oxide obtained by any of the first to fourth methods may be subjected to either or both pulverization and classification as necessary.

The oxyphosphorus compound is a compound that contains oxygen atoms and phosphorus atoms and that generates a phosphorus oxide or an oxoacid of phosphorus through heating or hydrolysis. Examples of the oxyphosphorus compound includes sodium dihydrogen phosphate, disodium hydrogen phosphate, sodium pyrophosphate, and sodium tripolyphosphate, and sodium pyrophosphate is preferable.

The following describes an example of a method for covering the bases with conductive layers. First, a raw material solution is prepared by dissolving a row material of a conductive compound in an acid solution (for example, hydrochloric acid). Next, the raw material solution is dripped in a dispersion of the bases in water in which the bases are dispersed, thereby covering the bases with conductive layers. The raw material solution is dripped under conditions of for example a dripping temperature of 60° C. or higher and 80° C. or lower and a dripping time of 1 hour or longer and 6 hours or shorter. In a case where the conductive compound is a metal oxide, chloride of metal atoms included in the metal oxide can be used for example as a raw material of the conductive compound. Specifically, in a case where the conductive compound is indium tin oxide, tin(IV) chloride pentahydrate and indium chloride can be used as a raw material of the conductive compound, for example. In dripping the raw material solution, it is preferable to keep the pH of the dispersion at at least 5.5 and no greater than 7.5 by simultaneously adding an alkaline aqueous solution (for example, an ammonia aqueous solution).

### (Colorant)

The toner mother particles may contain a colorant. The colorant can be a known pigment or dye that matches the color of the toner. The amount of the colorant is preferably at least 1 part by mass and no greater than 20 parts by mass relative to 100 parts by mass of the binder resin in terms of high-quality image formation using the toner.

The toner mother particles may contain a black colorant. Carbon black can for example be used as a black colorant. Alternatively, a colorant can be used that has been adjusted to a black color using colorants such as a yellow colorant, a magenta colorant, and a cyan colorant. A magnetic powder may be used as the black colorant. That is, the toner mother particles need not contain a colorant other than the magnetic powder.

### (Releasing Agent)

The toner mother particles may contain a releasing agent. The releasing agent is for example used in order to impart offset resistance to the toner. The amount of the releasing agent is preferably at least 1 part by mass and no greater than 20 parts by mass relative to 100 parts by mass of the binder resin in terms of impartment of sufficient offset resistance to the toner.

Examples of the releasing agent include aliphatic hydrocarbon-based waxes, oxides of aliphatic hydrocarbon-based waxes, plant waxes, animal waxes, mineral waxes, ester waxes containing a fatty acid ester as a main component, and waxes in which a part or all of a fatty acid ester has been deoxidized (for example, deoxidized carnauba wax). Examples of the aliphatic hydrocarbon-based waxes include polyolefin waxes (specific examples include low molecular weight polyethylene and low molecular weight polypropylene), polyolefin copolymers, microcrystalline wax, paraffin wax, and Fischer-Tropsch wax. Examples of the oxides of aliphatic hydrocarbon-based waxes include polyethylene oxide waxes and block copolymers of polyethylene oxide waxes. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes containing a fatty acid ester as a main component include montanic acid ester wax and castor wax. Preferably, the releasing agent is carnauba wax.

### (Charge Control Agent)

The toner mother particles may contain a charge control agent. The charge control agent is used for example in order to provide a toner excellent in charge stability or a charge rise characteristic. The charge rise characteristic of a toner is an indicator as to whether or not the toner can be charged to a specific charge level in a short period of time. In order to stably maintain positive chargeability of the toner, the toner mother particles preferably contain a positively chargeable charge control agent.

Examples of the positively chargeable charge control agent include azine compounds, direct dyes, nigrosine dyes, metal salts of naphthenic acids, metal salts of higher organic carboxylic acids, alkoxylated amine, alkylamide, quaternary ammonium salts, and resins having a quaternary ammonium cation group. Examples of the azine compounds include pyridazine, pyrimidine, pyrazine, 1,2-oxazine, 1,3-oxazine, 1,4-oxazine, 1,2-thiazine, 1,3-thiazine, 1,4-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1-2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline. Examples of the direct dyes include Azine Fast Red FC, Azine Fast Red 12BK, Azine Violet BO, Azine Brown 3G, Azine Light Brown GR, Azine Dark Green BH/C, Azine Deep Black EW, and Azine Deep Black 3RL. Examples of the nigrosine dyes include nigrosine BK, nigrosine BN, and nigrosine Z. Examples of the quaternary ammonium salts include benzyldecylhexylmethyl ammonium chloride, decyltrimethyl ammonium chloride, 2-(methacryloyloxy)ethyl trimethylammonium chloride, and dimethylaminopropyl acrylamide methyl chloride quaternary salt. In terms of providing a positively chargeable toner excellent in charge stability, the charge control agent is preferably a nigrosine dye or a resin having a quaternary ammonium cation group.

The amount of the charge control agent is preferably at least 0.1 parts by mass and no greater than 10 parts by mass relative to 100 parts by mass of the binder resin in terms of improving charge stability.

### (Shell Layers)

The shell layers are substantially constituted by a resin. The shell layers may be substantially constituted by a thermosetting resin or a thermoplastic resin, or may contain both a thermosetting resin and a thermoplastic resin. Both heat-resistant preservability and low-temperature fixability of the toner can be achieved for example by using low-melting toner cores and covering each toner core with a highly heat-resistant shell layer. An additive may be dispersed in the resin constituting the shell layers. The shell layers may entirely or partially cover the surfaces of the respective toner cores.

### (External Additive Particles)

The external additive particles are preferably inorganic particles, more preferably silica particles or particles of a metal oxide (specific examples include alumina, titanium oxide, magnesium oxide, and zinc oxide), and further preferably silica particles or titanium oxide particles. However, resin particles or particles of an organic oxide compound such as a fatty acid metal salt (specifically, zinc stearate or the like) may be used as the external additive particles.

In terms of inhibiting separation of the external additive particles from the toner mother particles and sufficiently exhibiting functions of the external additive particles, the amount of the external additive particles in the toner particles is preferably at least 0.1 parts by mass and no greater than 15.0 parts by mass relative to 100 parts by mass of the toner mother particles and more preferably at least 0.5 parts by mass and no greater than 5.0 parts by mass.

### [Toner Production Method]

The following describes an example of a production method of the toner according to the present disclosure. The production method of the toner includes a toner mother particle preparation process for preparing the toner mother particles. The production method of the toner may further include another process (for example, a later-described external addition process) after the toner mother particle preparation process.

### (Toner Mother Particle Preparing Process)

In the toner mother particle preparation process, the toner mother particles are prepared for example by a pulverization method or an aggregation method.

In an example of the pulverization method, the binder resin, the magnetic powder, the conductive titanium oxide particles, and another internal additive optionally added depending on necessity thereof are mixed together first. Subsequently, the resultant mixture is melt-kneaded using a melt-kneader (for example, a single or twin screw extruder). Next, the resultant melt-kneaded product is pulverized and classified. Through the above, the toner mother particles are obtained.

In an example of the aggregation method, respective types of fine particles of the binder resin, the magnetic powder, and the conductive titanium oxide particles, and another internal additive optionally added depending on necessity thereof are caused to aggregate in an aqueous medium including the fine particles of these types until the fine particles have a desired particle diameter. Through aggregation as above, aggregated particles containing the binder resins and the like are formed. Subsequently, the aggregated particles are heated to cause components contained in the aggregated particles to coalesce. Through the above, the toner mother particles are obtained.

### (External Addition Process)

In the present process, an external additive is attached to surfaces of the toner mother particles. Examples of a method for attaching the external additive to the surfaces of the toner mother particles include a method by which the external additive is attached to the surfaces of the toner mother particles by stirring and mixing the toner mother particles and external additive particles using for example a mixer.

### EXAMPLES

The following provides more specific description of the present disclosure through use of Examples. However, it should be noted that the present disclosure is not limited to the scope of Examples.

In Examples, where a concentration of a solution of a raw material compound of titanium oxide is expressed as “X [g/L] in terms of a titanium oxide equivalent concentration”, the concentration means a concentration at which X [g] of titanium oxide (TiO₂) is generated when 1 L of the solution of the raw material compound is caused to react at a percentage yield of 100%. Also, where an amount of a raw material compound of titanium oxide is expressed as “Y [g] in terms of titanium oxide equivalent mass”, the amount means an amount of the raw material compound from which Y [g] of titanium oxide (TiO₂) is generated when the raw material compound is caused to react at a percentage yield of 100%.

### [Additives]

Additives A to G used in Examples and Comparative Examples will be described first. The additives A to E each were a commercially available additive. The respective additives F and G were prepared by methods described below. Note that the additives A to C and G were conductive titanium oxide particles having an aspect ratio of at least 5.0.

### (Additives A to E)

Additive A: “FT-1000”, product of ISHIHARA SANGYO KAISHA, LTD., rutile type titanium oxide particles covered with conductive layers containing ATO.

Additive B: “FT-2000”, product of ISHIHARA SANGYO KAISHA, LTD., rutile type titanium oxide particles covered with conductive layers containing ATO.

Additive C: “FT-3000”, product of ISHIHARA SANGYO KAISHA, LTD., rutile type titanium oxide particles covered with conductive layers containing ATO.

Additive D: “FS-10P”, product of ISHIHARA SANGYO KAISHA, LTD., needle-shaped ATO particles.

Additive E: “ET-500 W”, product of ISHIHARA SANGYO KAISHA, LTD., ball-shaped titanium oxide particles covered with conductive layers containing ATO.

### (Preparation of Additive F)

Into a 5-L four-necked flask, an aqueous solution containing titanium tetrachloride (462.5 g in terms of mass of equivalent titanium oxide, 207.9 g/L in terms of titanium oxide equivalent concentration) was collected. The collected aqueous solution of titanium tetrachloride was then heated to 75° C. under stirring. Next, a slurry containing 37.5 g of seed crystals of rutile type titanium oxide dispersed therein was prepared and was added into the four-necked flask. Thereafter, the contents of the four-necked flask were heated at 75° C. for 2 hours for a hydrolysis reaction to obtain 2,941 mL of a slurry containing rutile type titanium oxide (concentration of titanium oxide: 163.2 g/L).

A 1-L beaker was charged with 500 mL of the above-described slurry containing rutile type titanium oxide. While the slurry was stirred, a powder of sodium carbonate (Na₂CO₃) was added to the slurry to adjust the pH of the slurry to 4. Then, a powder of sodium pyrophosphate (Na₄P₂O₇) was added to the slurry and mixed well. The amount of sodium pyrophosphate was 30 parts by mass relative to 100 parts by mass of the rutile type titanium oxide contained in the slurry. Thereafter, the slurry was filtered for dehydration to collect a wet cake of residue. The wet cake of the residue was loaded into a muffle furnace and baked at 870° C. for 3 hours. The resultant baked product was pulverized using a ball mill. Then, the pulverized product was added to deionized water and mixed for approximately 10 minutes using a mixer. The resultant mixture was then filtered and washed to remove a soluble salt therefrom. The resultant product was then dried. Through the above, the additive F being rutile type titanium oxide particles was obtained.

### (Preparation of Additive G)

By the method for preparing the additive F, 200 g of the additive F was prepared. By dispersing 200 g of the additive F in pure water, 2 L in total of a dispersion was prepared. The dispersion was heated to and kept at 70° C. A stannic acid liquid was prepared by dissolving 23.2 g of tin(IV) chloride pentahydrate (SnCl₄.5H₂O) in 200 mL of 2N hydrochloric acid. A total amount of the stannic acid liquid and 12% by mass of ammonia aqueous solution were dripped in parallel into the dispersion over approximately 90 minutes (first dripping). In the first dripping, the dripping amount of each liquid was adjusted to keep the pH of the dispersion in at least 6 and no greater than 7. Subsequently, 73.4 g of indium chloride (InCl₃) and 10.8 g of tin(IV) chloride pentahydrate (SnCl₄.5H₂O) were dissolved in 900 mL of 2N hydrochloric acid to prepare an indium-stannic acid liquid. The total amount of the indium-stannic acid liquid and 12% by mass of ammonia aqueous solution were dripped in parallel into the dispersion obtained by the first dripping over approximately 2 hours (second dripping). In the second dripping, the dripping amount of each liquid was adjusted to keep the pH of the dispersion at at least 6 and no greater than 7. Next, the resultant dispersion obtained by the second dripping was filtered and washed, and the resultant residue was dried at 120° C. for 10 hours. The dried product was subjected to heat treatment in a nitrogen gas flow (2 L/minute) at 550° C. for 1 hour. Through the above, the additive G being rutile type titanium oxide particles covered with conductive layers containing indium tin oxide (ITO) was obtained.

Next, a major axis, an aspect ratio, and a powder specific resistance of each of the additives A to G were measured. Details of the additives A to G and measurement results are shown in Table 1 below.

(Major Axis and Aspect Ratio)

With respect to each of the additives A to G, a sectional image (magnification: 30,000×) of the additive was captured using a scanning electron microscope (“JSM-6700F”, product of JEOL Ltd.). The major axes and the aspect ratios (major axis/minor axis) of 100 additive particles of the additive were measured in the captured sectional image, and the respective arithmetic means were taken to be a major axis and an aspect ratio of the additive. In measurement of the major axis of each additive particle of a target additive, two parallel imaginary lines were drawn so that the additive particle could be caught by the parallel imaginary lines and a distance between the parallel imaginary lines was maximum, and the distance therebetween was taken to be a measurement value for the major axis of the additive particle of the target additive. In measurement of the miner axis of the additive particle of the target additive, a third parallel imaginary line was also drawn so as to be separate at an equal distance from the respective two parallel imaginary lines and a distance measured along the third line between locations of the additive particle intersecting the third line was taken to be a measurement value for the minor axis of the additive particle of the target additive.

(Powder Specific Resistance)

With respect to each of the additives A to G, 5 g of the additive being a measurement target was loaded in a cylindrical measurement cell of an electric resistance meter (“R6561”, product of ADVANTEST CORPORATION). Note that the measurement cell included a fluororesin cylindrical portion and a bottom portion serving as a metal electrode. Subsequently, another electrode of the electric resistance meter was connected to the additive loaded in the measurement cell. To the electrode of the electric resistance meter, 1 kg of a load was applied. Subsequently, 10 V of DC voltage was applied across these electrodes and an electric resistance of the additive after 1 minute from a start of voltage application was measured. Note that 1 kg of the load was kept applied to the electrode of the electric resistance meter from the start to the end of the voltage application. The measurement was performed in an environment at a temperature of 25° C. and a relative humidity of 50%. Based on the value of the measured electric resistance and dimensions of the additive (specifically, the additive loaded in the measurement cell) in electric resistance measurement, a powder specific resistance (volume resistivity) of the additive was calculated using the following equation.

Powder specific resistance [Ω·cm]=(value of electric resistance) x (sectional area of current path)/(length of current path)

TABLE 1

| | | | | | Powder |
|---|---|---|---|---|---|
| | | Conduc- | | Major | specific |
| | | tive | Aspect | diameter | resistance |
| Additive | Base | layer | ratio | [μm] | [Ω · cm] |
| A | Titanium oxide | ATO | 11.0 | 2.0 | 10 |
| B | Titanium oxide | ATO | 13.0 | 3.0 | 10 |
| C | Titanium oxide | ATO | 19.0 | 5.0 | 100 |
| D | ATO | — | 20.0 | 2.0 | 10 |
| E | Titanium oxide | ATO | 1.2 | 0.5 | 10 |
| F | Titanium oxide | — | 13.0 | 2.0 | 1.00 × 10⁵ |
| G | Titanium oxide | ITO | 13.0 | 2.0 | 50 |

### Example 1

### (Toner Mother Particle Preparation Process)

Using an FM mixer (“FM-10”, product of Nippon Coke & Engineering Co., Ltd.), 100 parts by mass of a non-crystalline polyester resin (POLYESTER (registered Japanese trademark) HP-313″, product of The Nippon Synthetic Chemical Industry Co.) as a binder resin, 4.0 parts by mass of a carnauba wax (product of TOA KASEI CO., LTD.) as a releasing agent, 70 parts by mass of magnetite particles (“ALB-205”, product of Titan Kogyo, Ltd.) as a magnetic powder, 8 parts by mass of the additive A, and 1.0 parts by mass of a nigrosine dye (“BONTRON (registered Japanese trademark) N-71”, product of ORIENT CHEMICAL INDUSTRIES, Co., Ltd.) and 2.0 parts by mass of “ACRYBASE (registered Japanese trademark) FCA-201PS” (product of FUJIKURA KASEI CO., LTD., component: styrene-acrylic acid-based resin including a repeating unit derived from quaternary ammonium salt) each as a charge control agent were mixed together.

The resultant mixture was melt-kneaded using a twin screw extruder (“TEM-265S”, product of Toshiba Machine Co., Ltd.) under conditions of a material feeding speed of 5 kg/hour, a shaft rotational speed of 160 rpm, and a cylinder temperature of 130° C. The resulting melt-kneaded product was subsequently cooled. Thereafter, the cooled melt-kneaded product was coarsely pulverized using a pulverizer (“ROTOPLEX (registered Japanese trademark) Model 16/8”, product of former TOA KIKAI SEISAKUSHO, LTD.) at a setting particle diameter of 2 mm. The resultant coarsely pulverized product was finely pulverized using a pulverizer (“TURBO MILL Model RS”, product of FREUND-TURBO CORPORATION). The finely pulverized product was classified using a classifier (“ELBOW JET Model EJ-LABO”, product of Nittetsu Mining Co., Ltd.). Through the above, toner mother particles having a number average primary particle diameter of 7.0 μm were obtained.

### [External Addition Process]

Using an FM mixer (“FM-20B”, product of Nippon Coke & Engineering Co., Ltd.), 100 parts by mass of the resultant toner mother particles and 1 part by mass of hydrophobic silica particles (“AEROSIL (registered Japanese trademark) RA-200H”, product of Nippon Aerosil Co., Ltd.) as an external additive were mixed together at a rotational speed of 2,000 rpm for 15 minutes. Through the above, a toner (A-1) of Example 1 was obtained.

### Examples 2 to 5 and Comparative Examples 1 to 4

Toners (A-2) to (A-5) of Examples 2 to 5 and toners (B-1) to (B-4) of Comparative Examples 1 to 4 were produced by the same method as for the toner (A-1) of Example 1 in all aspects other than that types and amounts of additives added to the toner mother particles were changed as indicated in Table 2 below.

### Comparative Example 5

A toner (B-5) of Comparative Example 5 was produced by the same method as for the toner (A-1) of Example 1 in all aspects other than the following changes. In production of the toner (B-5) of Comparative Example 5, the additive A was not added in the toner mother particle preparation process. Furthermore, in production of the toner (B-5) of Comparative Example 5, 1 part by mass of hydrophobic silica particles (“AEROSIL (registered Japanese trademark) RA-200H”, product of Nippon Aerosil Co., Ltd.) and 1 part by mass of the additive A were used each as an external additive in the external addition process. That is, the additive A was internally added in production of the toner (A-1) of Example 1 while the additive A was externally added in production of the toner (B-5) of Comparative Example 5.

TABLE 2

| | | Toner mother particle | | External additive | |
|---|---|---|---|---|---|
| | | | Amount | | Amount |
| | Toner | Additive | [part by mass] | Additive | [part by mass] |
| Example 1 | A-1 | A | 8 | — | — |
| Example 2 | A-2 | B | 8 | — | — |
| Example 3 | A-3 | C | 8 | — | — |
| Example 4 | A-4 | A | 3 | — | — |
| Example 5 | A-5 | G | 8 | — | — |
| Comparative Example 1 | B-1 | D | 8 | — | — |
| Comparative Example 2 | B-2 | E | 8 | — | — |
| Comparative Example 3 | B-3 | F | 8 | — | — |
| Comparative Example 4 | B-4 | A | 11 | — | — |
| Comparative Example 5 | B-5 | — | — | A | 1 |

### <Evaluation>

Image density, fogging density, and toner scattering in each of the toners (A-1) to (A-5) of Examples 1 to 5 and the toners (B-1) to (B-5) of Comparative Examples 1 to 5 were evaluated by the following methods in a high-temperature and high-humidity environment (H/H environment) and a low-temperature and low-humidity environment (L/L environment).

### [Evaluation Apparatus]

An evaluation apparatus used was a monochrome printer (“ECOSYS (registered Japanese trademark) LS-4300DN”, product of KYOCERA Document Solutions Inc.). A toner (specifically, one of the toners (A-1) to (A-5) and (B-1) to (B-5)) was loaded in a black-color development device of the evaluation apparatus. A toner for replenishment use (specifically, the same toner as the toner loaded in the black-color development device) was loaded in a black-color toner container of the evaluation apparatus.

### [H/H Environment]

A printing durability test of printing an image pattern having an printing rate of 5% on 100,000 sheets of printing paper was performed in an environment at a temperature of 32.5° C. and a relative humidity of 80% (H/H environment). Specifically, after each printing of the first sheet (initial), the 50,000th sheet (50K), and the 100,000th sheet (100K) of the printing paper, an evaluation image including a solid image was printed on printing paper (evaluation target) in the printing durability test. An image density (ID) and a fogging density (FD) were measured for each sheet of the printing paper of the evaluation target. Specifically, a reflection density of the solid image on each sheet of the printing paper of the evaluation target was measured and was taken to be an image density (ID). Further, a reflection density A of a non-printed portion (blank portion) of the printing paper of each sheet of the evaluation target and a reflection density B of unused printing paper were measured. Then, a value calculated using an expression “(reflection density A)−(reflection density B)” was taken to be a fogging density (FD). Each reflection density was measured using a reflectance densitometer (“RD914”, product of X-Rite Inc.). After the printing durability test, the interior of the evaluation apparatus was visually observed to determine the presence or absence of toner scattered from the development device. Respective evaluation standards for image density, fogging density, and toner scattering were indicated below. The measurement results are indicated in Table 3.

(Image Density Evaluation Standards)

A: ID of at least 1.4

B: ID of at least 1.3 and less than 1.4

C: ID of less than 1.3

(Fogging Density Evaluation Standards)

A: FD of no greater than 0.003

B: FD of greater than 0.003 and no greater than 0.007

C: FD of greater than 0.007

(Toner Scattering Evaluation Standards)

Absent: Toner scattering could not be visually recognized.

Present: Toner scattering could be visually recognized.

TABLE 3

| | | H/H environment | | | | | | |
|---|---|---|---|---|---|---|---|---|
| | | Initial | | 50K | | 100K | | Toner |
| | Toner | ID | FD | ID | FD | ID | FD | scattering |
| Example 1 | A-1 | 1.435 | 0.001 | 1.432 | 0.001 | 1.434 | 0.001 | Absent |
| Example 2 | A-2 | 1.440 | 0.002 | 1.445 | 0.002 | 1.432 | 0.002 | Absent |
| Example 3 | A-3 | 1.433 | 0.002 | 1.450 | 0.002 | 1.456 | 0.002 | Absent |
| Example 4 | A-4 | 1.450 | 0.001 | 1.440 | 0.002 | 1.420 | 0.002 | Absent |
| Example 5 | A-5 | 1.420 | 0.001 | 1.422 | 0.001 | 1.428 | 0.001 | Absent |
| Comparative | B-1 | 1.465 | 0.002 | 1.422 | 0.002 | 1.421 | 0.002 | Absent |
| Example 1 | | | | | | | | |
| Comparative | B-2 | 1.468 | 0.002 | 1.422 | 0.002 | 1.389 | 0.002 | Absent |
| Example 2 | | | | | | | | |
| Comparative | B-3 | 1.465 | 0.002 | 1.422 | 0.002 | 1.421 | 0.002 | Absent |
| Example 3 | | | | | | | | |
| Comparative | B-4 | 1.289 | 0.004 | 1.245 | 0.005 | 1.239 | 0.008 | Present |
| Example 4 | | | | | | | | |
| Comparative | B-5 | 1.243 | 0.004 | 1.255 | 0.003 | 1.243 | 0.003 | Present |
| Example 5 | | | | | | | | |

### [L/L Environment]

Evaluation of each of image density, fogging density, and toner scattering was performed by the same method as for the evaluation in the H/H environment in all aspects other than that the temperature and the relative humidity were respectively changed to 10° C. and 20% (L/L environment) and the printing rate of the image pattern printed in the printing durability test was changed to 2%. The measurement results are indicated in Table 4.

TABLE 4

| | | L/L environment | | | | | | |
|---|---|---|---|---|---|---|---|---|
| | | Initial | | 50K | | 100K | | Toner |
| | Toner | ID | FD | ID | FD | ID | FD | scattering |
| Example 1 | A-1 | 1.453 | 0.002 | 1.451 | 0.002 | 1.443 | 0.002 | Absent |
| Example 2 | A-2 | 1.432 | 0.002 | 1.409 | 0.002 | 1.402 | 0.003 | Absent |
| Example 3 | A-3 | 1.445 | 0.002 | 1.402 | 0.003 | 1.400 | 0.003 | Absent |
| Example 4 | A-4 | 1.421 | 0.002 | 1.405 | 0.002 | 1.400 | 0.002 | Absent |
| Example 5 | A-5 | 1.412 | 0.002 | 1.405 | 0.002 | 1.403 | 0.002 | Absent |
| Comparative | B-1 | 1.398 | 0.002 | 1.402 | 0.002 | 1.401 | 0.002 | Absent |
| Example 1 | | | | | | | | |
| Comparative | B-2 | 1.423 | 0.002 | 1.343 | 0.004 | 1.312 | 0.004 | Present |
| Example 2 | | | | | | | | |
| Comparative | B-3 | 1.398 | 0.002 | 1.320 | 0.003 | 1.276 | 0.005 | Present |
| Example 3 | | | | | | | | |
| Comparative | B-4 | 1.423 | 0.002 | 1.432 | 0.002 | 1.433 | 0.002 | Absent |
| Example 4 | | | | | | | | |
| Comparative | B-5 | 1.398 | 0.002 | 1.388 | 0.002 | 1.395 | 0.002 | Absent |
| Example 5 | | | | | | | | |

A toner can be evaluated as good in image density stability if the image density of the toner on each of the first sheet, the 50,000th sheet, and the 100,000th sheet was rated as “A” in both the H/H environment and the L/L environment, and evaluated as poor in image density stability if the image density of the toner on any of the first sheet, the 50,000th sheet, and the 100,000th sheet was rated as “B” or “C” in either the H/H environment or the L/L environment. It can be evaluated that use of a toner could prevent occurrence of fogging if the fogging density of the toner in printing on each of the first sheet, the 50,000th sheet, and the 100,000th sheet was rated as “A” in both the H/H environment and the L/L environment, and evaluated that use of a toner could not prevent occurrence of fogging if the fogging density of the toner in printing on any of the first sheet, the 50,000th sheet, and the 100,000th sheet was rated as “B” or “C” in either the H/H environment or the L/L environment. It can be evaluated that use of a toner could prevent occurrence of toner scattering if the toner scattering of the toner in printing on each of the first sheet, the 50,000th sheet, and the 100,000th sheet was rated as “Absent” in both the H/H environment and the L/L environment, and evaluated that use of a toner could not prevent occurrence of toner scattering if the toner scattering of the toner in printing on any of the first sheet, the 50,000th sheet, and the 100,000th sheet was rated as “Present” in either the H/H environment or the L/L environment.

Each of the toners (A-1) to (A-5) of Examples 1 to 5 included toner particles each including a toner mother particle. The toner mother particles contained a binder resin, a magnetic powder, and conductive titanium oxide particles. The conductive titanium oxide particles had an aspect ratio of at least 5.0. The amount of the conductive titanium oxide particles was at least 1 part by mass and no greater than 10 parts by mass relative to 100 parts by mass of the binder resin. As shown in Tables 3 and 4, each of the toners (A-1) to (A-5) of Examples 1 to 5 was excellent in image density stability and use of the toner could prevent occurrence of fogging and toner scattering.

By contrast, each of the toners (B-1) to (B-5) of Comparative Examples 1 to 5, which did not have the above features, was not excellent in image density stability and the use of at least one of the toners could not prevent occurrence of fogging or toner scattering.

Specifically, the additive D used in the toner (B-1) of Comparative Example 1 included needle-shaped ATO particles and was inferior to conductive titanium oxide particles in strength (readily broken). Thus, it is thought that the needle-shaped ATO particles could not impart sufficient conductivity to the toner particles. As a result, toner particles in toner chains of the toner (B-1) of Comparative Example 1 could not be sufficiently charged. It is accordingly concluded that the use of the toner (B-1) of Comparative Example 1 could not obtain an image having sufficient image density on at least one of the first sheet, the 50,000th sheet, and the 100,000th sheet in the L/L environment.

The additive E used in the toner (B-2) of Comparative Example 2 included conductive titanium oxide particles having an aspect ratio of less than 5.0, and therefore, it is thought that conductivity could not be sufficiently imparted to the toner particles. As a result, toner particles in toner chains of the toner (B-2) of Comparative Example 2 could not be sufficiently charged. It is accordingly concluded that the use of the toner (B-2) of Comparative Example 2 could not obtain an image having sufficient image density and prevent occurrence of fogging and toner scattering in printing on at least one of the first sheet, the 50,000th sheet, and the 100,000th sheet in the L/L environment.

The additive F used in the toner (B-3) of Comparative Example 3 included no conductive layers, and therefore, it is though that conductivity could not be sufficiently imparted to the toner particles. As a result, toner particles in toner chains of the toner (B-3) of Comparative Example 3 could not be sufficiently charged. It is accordingly concluded that the use of the toner (B-3) of Comparative Example 3 could not obtain an image having sufficient image density and prevent occurrence of fogging and toner scattering in printing on at least one of the first sheet, the 50,000th sheet, and the 100,000th sheet in the L/L environment.

The toner (B-4) of Comparative Example 4 included over 10 parts by mass of the conductive titanium oxide particles relative to 100 parts by mass of the binder resin, and therefore, it is thought conductivity was excessively imparted to the toner particles. As a result, the toner (B-4) of Comparative Example 4 could not be sufficiently charged in contact charge with a development roller. It is accordingly concluded that the use of the toner (B-4) of Comparative Example 4 could not obtain an image having sufficient image density and prevent occurrence of fogging and toner scattering in printing on at least one of the first sheet, the 50,000th sheet, and 100,000th sheet in the H/H environment.

The toner (B-5) of Comparative Example 5 included conductive titanium oxide particles attached to each surface of the toner mother particles, and therefore, it is thought that conductivity was excessively imparted to the toner particles. As a result, the use of the toner (B-5) of Comparative Example 5 could not be sufficiently charged in contact charge with the development roller. It is accordingly concluded that the use of the toner (B-5) of Comparative Example 5 could not obtain an image having sufficient image density and prevent occurrence of fogging and toner scattering in printing on at least one of the first sheet, the 50,000th sheet, and 100,000th sheet in the H/H environment.

What is claimed is:

1. A toner comprising toner particles each including a toner mother particle, wherein
the toner mother particles contain a binder resin, a magnetic powder, and conductive titanium oxide particles,
the conductive titanium oxide particles have an aspect ratio of at least 5.0, and
an amount of the conductive titanium oxide particles is at least 2 parts by mass and no greater than 10 parts by mass relative to 100 parts by mass of the binder resin.

2. The toner according to claim 1, wherein
the conductive titanium oxide particles each have a base containing titanium oxide and a conductive layer covering the base.

3. The toner according to claim 2, wherein
the conductive layers contain tin oxide.

4. The toner according to claim 1, wherein
the amount of the conductive titanium oxide particles is at least 5 parts by mass and no greater than 10 parts by mass relative to 100 parts by mass of the binder resin.

5. The toner according to claim 1, wherein
the conductive titanium oxide particles have a major axis of at least 1.0 μm and no greater than 10.0 μm.
